(19) United States
(12) Patent Application Publication
(10) Pub. No.: US 2012/0204630 A1
(43) Pub. Date: Aug. 16, 2012

(54) METHOD FOR OPERATING A CRASH SIMULATION DEVICE, AUXILIARY DEVICE FOR A CRASH SIMULATION DEVICE, AND CRASH SIMULATION DEVICE HAVING SUCH AN AUXILIARY DEVICE

(75) Inventors: Olaf Manfred Wallich, Riedstadt (DE); Willi Elsenheimer, Floersheim (DE)

(73) Assignee: GM GLOBAL TECHNOLOGY OPERATIONS LLC, Detroit, MI (US)

(21) Appl. No.: 13/390,371

(22) PCT Filed: Jul. 3, 2010
(86) PCT No.: PCT/EP2010/004031

§ 371 Date: May 4, 2012

(30) Foreign Application Priority Data
Aug. 21, 2009 (DE) 10 2009 038 455.3

(51) Int. Cl. G01M 15/00

(52) U.S. Cl. 73/118.01

(57) ABSTRACT

A method is provided for operating a crash simulation device for motor vehicles. Providing an accelerable slide, fastening a first additional mass to the slide, performing a preliminary test subject to capturing of the acceleration curve, comparing the captured acceleration curve with a desired acceleration curve, performing a further preliminary test with changed setting of the components that are decisive for the acceleration curve of the slide. If the sensed acceleration curve deviates from the desired acceleration curve, removing the first additional mass from the slide when the captured acceleration curve corresponds to the set acceleration curve, fastening to the slide, arranging a moveable dummy and carrying out a real test with the settings of the components decisive for the acceleration curve made in the preliminary test or the preliminary tests. Arranging a moveable second additional mass on the slide before carrying out the at least one of the test.

### CROSS-REFERENCE TO RELATED APPLICATIONS

This application is a U.S. National-Stage entry under 35 U.S.C. §371 based on International Application No. PCT/EP2010/004031, filed Jul. 3, 2010 and which claims priority to German Application No. 10 2009 038 455.3, filed Aug. 21, 2009, which are all hereby incorporated in their entirety by reference.

### TECHNICAL FIELD

The technical field relates to a method for operating a crash simulation device for motor vehicles. In addition, the technical field relates to an additional device for an accelerable slide of a crash simulation device and a crash simulation device having an additional device.

### BACKGROUND

From the prior art, crash simulation devices for motor vehicles are known, which comprise an accelerable slide, on which a vehicle or vehicle part and a moveable dummy can be arranged, and an acceleration or driving device for driving or accelerating the slide.

Preliminary tests are carried out before the previously mentioned real test to adjust the crash simulation device before the real test. In the real test, vehicle or vehicle part is fastened to the slide and the moveable dummy arranged on the slide in such a manner that the acceleration curve of the slide copies the acceleration curve during a real collision as exactly as possible,. Within the scope of the preliminary tests, arranging the vehicle or vehicle parts and the dummy on the accelerable slide is omitted in order to protect the components that are expensive and very sensitive. Thus, merely an additional mass whose weight substantially corresponds to the total weight of the vehicle or vehicle part in combination with the dummy used later is fastened to the accelerable slide. The additional mass in this case is immovably fastened to the slide of the crash simulation device. Following, the previously mentioned preliminary test is carried out, in which the slide with the additional mass fastened thereon is accelerated through the acceleration or driving device of the crash simulation device.

Within the scope of the preliminary test, the acceleration curve of the slide is captured in order to compare the captured acceleration curve with a desired acceleration curve of the slide. The desired acceleration curve substantially corresponds to an acceleration curve during a real collision or impact of the motor vehicle. Should the captured acceleration curve of the slide deviate from the desired acceleration curve, the settings of the components of the crash simulation device that are decisive for the acceleration curve of the slide are initially changed in order to subsequently conduct a further preliminary test. Thus, within the scope of the setting of the components of the crash simulation device that are decisive for the acceleration curve of the slide, for example, the impulse exerted by the acceleration device on the slide could be changed. It is likewise conceivable to change a braking device that provided on the slide or its settings in order to approximate the acceleration curve captured to the desired acceleration curve. Should the acceleration curve captured within the scope of the second preliminary test again deviate from the desired acceleration curve, the settings of the crash simulation device are changed again in order to subsequently conduct another preliminary test, etc.

Should the comparison of the last captured acceleration curve coincide with the desired acceleration curve, the settings of the components of the crash simulation device that are decisive for the acceleration curve of the slide are found, which lead to an acceleration curve of the slide that is acceleration curve close to reality as possible. Thus, the preliminary tests are aborted to conduct a real test. For this purpose, the additional mass from the preliminary tests is initially removed from the slide to subsequently and immovably fasten a vehicle or vehicle part to the slide or the crash simulation device. Furthermore, a moveable dummy is arranged on the slide or/and the vehicle or vehicle part. Following, at least one real test is carried out with the settings made in the preliminary test or the preliminary tests of the components of the crash simulation device decisive for the acceleration curve of the slide.

A known method for operating a crash simulation device for motor vehicles has proved itself insofar as the vehicle or vehicle part and, in particular, the expensive dummy are protected within the scope of the preliminary tests for setting the crash simulation device, more so since during the preliminary tests merely an additional mass is employed, the weight of which corresponds to the gross weight of vehicle or vehicle part and the moveable dummy. The disadvantage, however, of the known procedure is in that the acceleration curve of the slide determined and set within the scope of the preliminary tests can only be inadequately reproduced within the scope of the real test, or not at all. On the contrary, individual deviations of the acceleration curve captured in the real test are noticed compared with the desired acceleration curve, which prevent a realistic simulation of the real crash behaviour of a motor vehicle. In other words, the crash simulation device set in the manner described above has a relatively low repetitive accuracy, so that the number of the real tests rises because of an increased number of unsuccessful tests, which ultimately leads to increased costs. The mentioned costs in this case are mostly due to dummies provided with a complex sensor system, which have to be exchanged or replaced more frequently because of the large number of real tests.

It is therefore at least one object is providing a method for operating a crash simulation device for motor vehicles, which on the one hand can be carried out in a material-saving manner within the scope of the preliminary tests and on the other hand has a high repetitive accuracy within the scope of the real tests in order to avoid cost-intensive unsuccessful tests and to reduce the number of the real tests. In addition, at least another object is to create an additional device for a crash simulation device that can be used in the preliminary tests of the method and leads to the aforementioned advantages. Furthermore, the at least another object is based on providing a crash simulation device having such an advantageous additional device. Moreover, other objects, desirable features and characteristics will become apparent from the subsequent summary and detailed description, and the appended claims, taken in conjunction with the accompanying drawings and this background.

### SUMMARY

The method according to an embodiment serves for the operation of a crash simulation device for motor vehicles, more specifically for the setting and the operation of a crash simulation device, and comprises the steps subsequently described in more detail. Initially, a crash simulation device is made available having an accelerable slide. In this connection, reference is made, for example, to the crash simulation devices known from the prior art, which as a rule have a slide that can be accelerated along a guide rail, which can be accelerated along the guide rail by a suitable acceleration or driving device. Here, the slide is preferentially designed in such a manner that vehicle parts and dummies can be simply arranged or fastened thereon. During the further course of the method, a first additional mass is fastened to the slide to subsequently conduct a preliminary test with the crash simulation device. In contrast with the methods for operating a crash simulation device known from the prior art, however, at least one moveable second additional mass is additionally arranged on the slide, before the preliminary test or the preliminary tests are carried out. A moveable second additional mass in this case is to mean an additional mass that in contrast with the first additional mass is moveably arranged on the slide relative to the slide.

Within the scope of the preliminary test, the acceleration curve of the slide is captured to subsequently or at the same time compare the captured acceleration curve with a desired acceleration curve of the slide. The preset desired acceleration curve substantially reflects the acceleration curve during a real collision of a motor vehicle with an obstacle. Here it is preferred when the desired acceleration curve of the slide is defined in such a manner that it is arranged in a corridor between a preset upper limit acceleration curve and a preset lower limit acceleration curve. Should the comparison of the captured acceleration curve deviate from the desired acceleration curve, in that for example the captured acceleration curve is in part arranged above the upper limit acceleration curve or in part below the lower limit acceleration curve, the settings of the components of the crash simulation device that are decisive for the acceleration curve of the slide are initially changed. Thus, the impulse on the slide exerted by the acceleration device or driving device can be changed, for example. Alternatively or additionally, it is likewise conceivable, however, to change the setting of another component of the crash simulation device that is decisive for the acceleration curve of the slide, such as for example setting of a braking device of the slide that may be present, which is able to influence the acceleration curve of said slide.

Once the settings of the components of the crash simulation device that are decisive for the acceleration curve of the slide have been changed, a further preliminary test is carried out. In this case, the acceleration curve of the slide is also captured and compared with the desired acceleration curve of the slide. These preliminary tests are carried out until through suitable setting of the components of the crash simulation device, which are decisive for the acceleration curve of the slide an acceleration curve of the slide, is achieved that corresponds to the desired acceleration curve, i.e., that is arranged for example within the previously mentioned corridor between the upper limit acceleration curve and the lower limit acceleration curve.

If the captured acceleration curve corresponds to the preset desired acceleration curve, the suitable settings of the components of the crash simulation device that are decisive for the acceleration curve of the slide have been found within the scope of the preliminary tests, which can be maintained following the end of the preliminary tests in order to reproduce a corresponding acceleration curve of the slide also within the scope of the real test described below. Prior to this real test, however, the first additional mass and preferentially also the second additional mass is initially removed from the slide in order to subsequently fasten a vehicle or vehicle part to the slide and arrange at least one moveable dummy on the slide or/and the vehicle or vehicle part. Following, the previously mentioned real test, with which the vehicle or vehicle part is fastened to the slide and the moveable dummy is arranged on the slide or/and the vehicle or vehicle part, is carried out. The settings of the components of the crash simulation device that are decisive for the acceleration curve of the slide made in the preliminary test or the preliminary tests are used.

Due to the additional arrangement of a moveable second additional mass on the slide during the preliminary test or the preliminary tests, the settings of the components of the crash simulation device that are decisive for the acceleration curve of the slide can be optimized in a manner that significantly increases the repetitive accuracy within the scope of the real tests, so that the number of unsuccessful tests during the carrying-out of the real tests can be drastically reduced. In this way, the material consumption with respect to the vehicle or vehicle part used and the cost-intensive moveable dummy is not only significantly reduced within the scope of the preliminary tests, but also within the scope of the real tests. This results in that the total costs of the method for operating the crash simulation device for motor vehicles can be greatly reduced.

In an embodiment of the method, the second additional mass, which within the scope of the preliminary tests was moveably arranged on the slide or/and the additional mass, is removed from the slide before carrying out the real test so as not to negatively influence the repetitive accuracy already mentioned previously during the real tests. In principle, the second additional mass can be arranged directly on the slide of the crash simulation device. However, it is likewise possible to directly arrange the second additional mass on the slide, in that it is arranged on the first additional mass, as is the case in a further embodiment of the method. Thus, the second additional mass could, for example, be moveably arranged initially on the first additional mass before the first additional mass is immovably fastened to the slide of the crash simulation device.

In an embodiment of the method, which is based on the previously described embodiment, the second additional mass, which is arranged on the first additional mass, is subsequently arranged on the slide together with the first additional mass or/and removed with the first additional mass from the slide. In this way, merely the first additional mass has to be fastened to the slide or removed from the slide, as a result of which the second additional mass arranged on the slide is simultaneously arranged on the slide or removed from the slide, so that the test setup for the preliminary tests can be created relatively quickly.

In order to achieve a test setup even within the scope of the preliminary test that is suitable to achieve a high repetitive accuracy of the acceleration curve of the slide also in the real test, the second additional mass in a particularly preferred embodiment of the method is arranged on the slide or the first additional mass in such a manner, that the second additional mass is initially freely moveable along a first path and subsequently, subject to resilient or/and damping, preferentially resilient support on the slide or the first additional mass, is moveable along a second path. With this test arrangement within the scope of the preliminary test, the movement curve of a vehicle occupant is thus also substantially simulated, who because of a collision initially moves freely along a first path and following this moves along a second path subject to resilient or/and damping support on an airbag or/and a safety belt. If, therefore, such an arrangement of a second additional mass is already chosen within the scope of the preliminary tests, a high repetitive accuracy in particular can be achieved during the real tests, during which a dummy is supported on the vehicle or vehicle part by means of an airbag or/and a safety belt. However, the repetitive accuracy of the real tests, during which other dummies, such as for example freely moveable load material dummies are used, can be increased through the described test setup.

In another embodiment of the method, which is based on the embodiment described above, the second additional mass is furthermore arranged on the slide or the first additional mass in such a manner, that the second additional mass following the second path is supported on the slide or the first additional mass in a damping manner. The second additional mass describes a movement curve that on the one hand substantially corresponds to the movement curve of a dummy used in the real test and on the other hand has a corresponding influence on the acceleration curve of the slide through mass coupling. Thus, the acceleration curve of the slide is approximated to the acceleration curve during a real collision of a motor vehicle with an obstacle during the preliminary test with such accuracy, that the real tests carried out with the crash simulation device is repeated with particular accuracy with the moveable dummy on the slide. The high repetitive accuracy is capable of reducing the material employed and thus the costs involved.

According to a further embodiment of the method, an additional device is fastened to the slide or the first additional mass before the preliminary test or this additional device is already fastened to the slide or to the first additional mass. This additional device comprises the previously mentioned second additional mass, a guiding device for guiding the second additional mass relative to the additional device and a spring or/and damping device. The additional device after the carrying-out of the preliminary test or prior to the carrying-out of the real test is entirely or partially removed from the slide. This is an indication that the additional device in principle is formed in part of constituent parts on the slide. However, it is preferred if the additional device is entirely removed from the slide or fastened to the slide. In this manner, the constituent parts of the additional device can be saved during the carrying-out of the real tests, so that their lifespan is increased. In the case of an additional device having the second additional mass, the guiding device and the spring or/and damping device is fastened to the slide as a unit or removed from the slide it is advantageous that the preliminary test setup and the real test setup can be produced particularly quickly, more so since only few interfaces between the slide and the additional device have to be taken into account.

In order to achieve a particularly high repetitive accuracy with the real tests, a second additional mass with a weight used in a further embodiment of the method. The weight of the second additional mass substantially corresponds to the weight of the dummy used in the real test. This embodiment comprises the use of a second additional mass and of a dummy, whose weights are matched to each other, as well as the use of a second additional mass and multiple dummies The weight of the second additional mass then substantially corresponds to the total weight of the dummies In addition, this embodiment comprises the use of multiple second additional masses, of which each individual second additional mass substantially has the weight of one of the dummies used in the real test. Alternatively or preferentially additionally, a first additional mass with a weight is furthermore used. The weight of the first additional mass substantially corresponds to the weight of the vehicle or vehicle part used in the real test, as a result of which the repetitive accuracy during the real tests can be further increased.

As already mentioned, the high material use and the high costs within the scope of the real tests substantially result from the fact that expensive, elaborate dummies susceptible to malfunctioning are used. Since the number of the unsuccessful tests and thus the number of the real tests can be reduced through the method, dummies who are assigned a sensor system for capturing the forces, accelerations or/and weights which act on the dummies are used in a further embodiment of the method. Here, the mentioned sensor system is partially or entirely received in the dummy. Due to the low number of real tests achieved through the method, such cost-intensive dummies are employed. With this embodiment, it is preferred if the dummy is a person dummy, which particularly preferably is supported on the vehicle or vehicle part in the manner described before, namely with a safety belt or/and an airbag. In addition, it is preferred if the second additional mass that is used in the preliminary tests is not assigned a sensor system in order to keep the costs within the scope of the preliminary tests low.

The additional device for an accelerable slide of a crash simulation device according to an embodiment in the preliminary test or the preliminary tests of the method. Here, the additional device, is configured for fastening to a slide of a crash simulation device, and comprises at least one additional mass that is moveable along a guiding device. Thus, the guiding device can for example be a guide rail on which the moveable additional mass is guided. In addition, suitable rollers can, for example, be provided on the moveable additional mass via which the moveable additional mass is supported on the guide rails or another fixed part of the additional device.

In another embodiment of the additional device, the additional mass is guided by the guiding device freely moveably along a first path. In another embodiment of the additional device, the additional device comprises a support section, which can be directly or indirectly fastened to the slide of the crash simulation device, and a spring or/and damping device, preferentially spring device, acting between the support section and the additional mass, so that the additional mass following the first path is guided by the guiding device along a second path subject to the resilient or/and damping, preferentially resilient support of the additional mass. As already mentioned previously making reference to the method, an additional device is created having an additional mass that simulates the movement curve or the acceleration curve of a dummy moveably arranged on the slide in the real test with particular accuracy, so that the additional device, which can be used during the preliminary tests of the method, brings about a particularly high repetitive accuracy within the scope of the real tests of the method.

According to another embodiment of the additional device, a damping device is furthermore provided that acts between the support section and the additional mass in such a manner that the additional mass following the second path is supported on the support section in a damping manner. With regard to the advantages of an additional device having such a damping device reference is made to the advantages of the previously described method. The second additional mass following the second path is supported on the slide or the first additional mass in a damping manner.

In order to be able to adapt the weight of the additional mass of the additional device in a particularly quickly and simple manner to the weight of the dummy used in the real test, the additional mass in a further particularly advantageous embodiment of the additional device is exchangeably arranged or guided on the additional device.

The crash simulation device for a motor vehicle comprises an accelerable slide. The slide the additional device is fastened. In an embodiment of the crash simulation device, the additional device is wholly or partially detachably fastened to the slide. It is preferred, however, if the additional device can be entirely removed from the slide in order to protect the constituent parts of the additional device from damage during the real tests within the scope of the method described above.

### BRIEF DESCRIPTION OF THE DRAWINGS

The present invention will hereinafter be described in conjunction with the following drawing figures, wherein like numerals denote like elements, and:

FIG. 1 is a curve diagram illustrating an embodiment of the method for operating a crash simulation device for motor vehicles;

FIG. 2 is a schematic representation of a crash simulation device in lateral view;

FIG. 3 is the crash simulation device from FIG. 2 with a first additional mass fastened to the slide and a second additional mass moveably arranged on the slide;

FIG. 4 is the crash simulation device from FIG. 3 in a first phase of the preliminary test;

FIG. 5 is the crash simulation device from FIG. 4 in a second phase of the preliminary test;

FIG. 6 is the crash simulation device from FIG. 5 in a third phase of the preliminary test;

FIG. 7 is the crash simulation device from FIG. 6 in a fourth phase of the preliminary test; and

FIG. 8 is the crash simulation device from FIG. 2 to FIG. 7 after the preliminary tests and before carrying-out the real tests.

### DETAILED DESCRIPTION

The following detailed description is merely exemplary in nature and is not

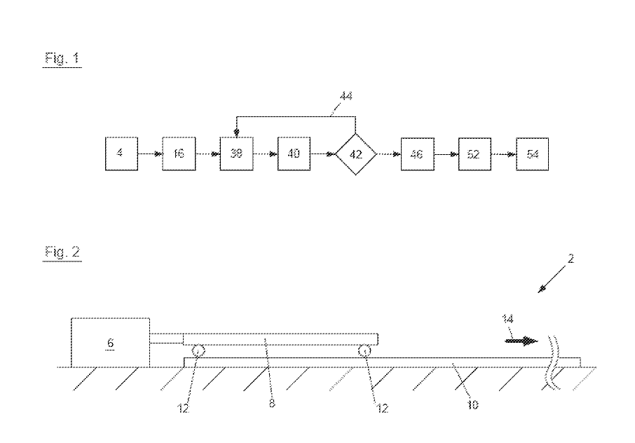

intended to limit application and uses. Furthermore, there is no intention to be bound by any theory presented in the preceding background or the following detailed description. FIG. 1 shows a curve diagram to illustrate an embodiment of the method for operating a crash simulation device 2 for motor vehicles. Thus, in a first method step 4 of the method, a crash simulation device 2 is provided, which is schematically represented in FIG. 2.

Thus, the crash simulation device 2 comprises an acceleration or driving device 6. In addition to this, the crash simulation device 2 comprises a slide 8, which is guided along a guiding device, which in the present example is formed by guide rails 10. The slide 8 in the embodiment shown is supported on the guide rails 10 via rollers 12. Thus, the slide 8 of the crash simulation device 2 can be accelerated in direction 14 along the guide rails 10 with the help of the acceleration device 6. The direction 14 can also be called the shot direction of the slide 8. Here, any drive able to accelerate the slide 8 in a manner causing an acceleration curve of the slide 8 that corresponds to the acceleration curve during a real collision of a motor vehicle with an obstacle is possible as acceleration device 6.

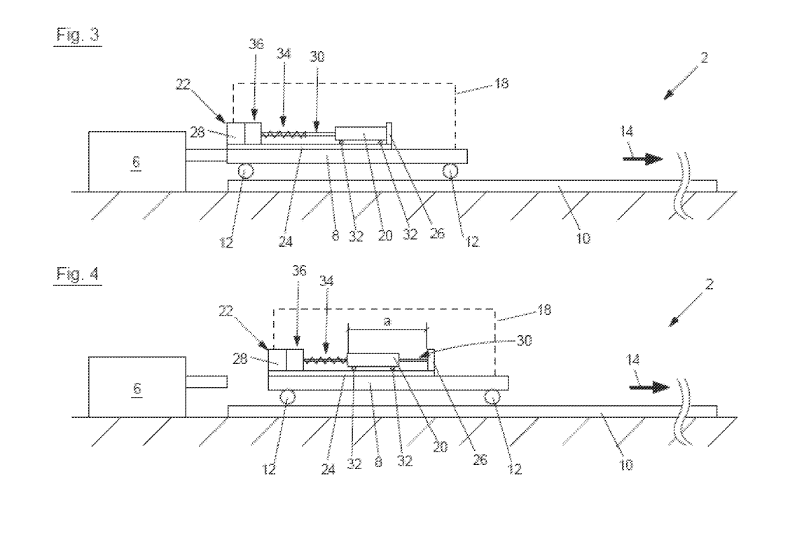

In a following method step 16, a first additional mass 18 and a moveable second additional mass 20 are arranged on the slide 8 of the crash simulation device 2. The first additional mass 18, which for the sake of clarity is merely hinted in interrupted line in FIG. 3, is fastened to the slide 8 in such a manner that it is connected to the slide 8 in a fixed manner and cannot be moved relative to the slide 8. The first additional mass 18 in this case has a weight that substantially corresponds to the weight of the vehicle or vehicle part used in the real test described later on. It is noted that the first additional mass can also be designed in multiple parts.

The second additional mass 20 is designed as part of an additional device 22 for the accelerable slide 8 of the crash simulation device 2. The additional mass 20 in this case has a weight that substantially corresponds to the weight of the dummy used in the real test described in more detail later on. This additional device 22 (FIG. 3) initially comprises a baseplate 24, by means of which the additional device 22 is detachably or releasably fastened to the slide 8. The baseplate 24 is thus immovably fastened to the slide 8. Alternatively, the additional device 22 could also be immovably fastened to the first additional mass 18 via the baseplate 24.

On the baseplate 24, a first support section 26 and a second support section 28 arranged in the opposite direction on the baseplate 24 is provided in the direction 14, wherein the second support section 28 is spaced from the first support section 26 in the opposite direction. Between the first and the second support section 26, 28 extends a guiding device 30 along which the previously mentioned second additional mass 20 is guided and moveable. For this purpose, the second additional mass 20 is guided on the one hand on the guiding device 30 and on the other hand supported on the top of the baseplate 24 via rollers 32. Thus, the second additional mass 20 in contrast with the first additional mass 18 is moveably arranged relative to the slide 8 on the slide 8.

Between the second support section 28 and the second additional mass 20 a spring or/and damping device 34 is furthermore provided, which in the embodiment shown is designed as spring device. In addition, a damping device 36 is furthermore provided between the second support section 28 and the second additional mass 20. The mode of operation of the spring or/and damping device 34 and of the damping device 36 is described in more detail in the following.

Following, a preliminary test is subsequently performed in the method step 38 (FIG. 1) with the crash simulation device 2 and the setup described making reference to FIG. 3, during which the slide 8 is accelerated or shot in direction 14 through the acceleration device 6. The individual phases of the preliminary test are shown in FIG. 4 to FIG. 7.

In the first phase of the preliminary test shown in FIG. 4, the slide 8 is shot through the acceleration device 6 in the direction 14, as a result of which the second additional mass 20 due to its inertia initially moves freely along a first path a relative to the slide 8. Along the first path a, friction forces between the second additional mass 20 and the guiding device 30 and between the rollers 32 and the baseplate 24 are acting at the most, so that this can be called free mobility.

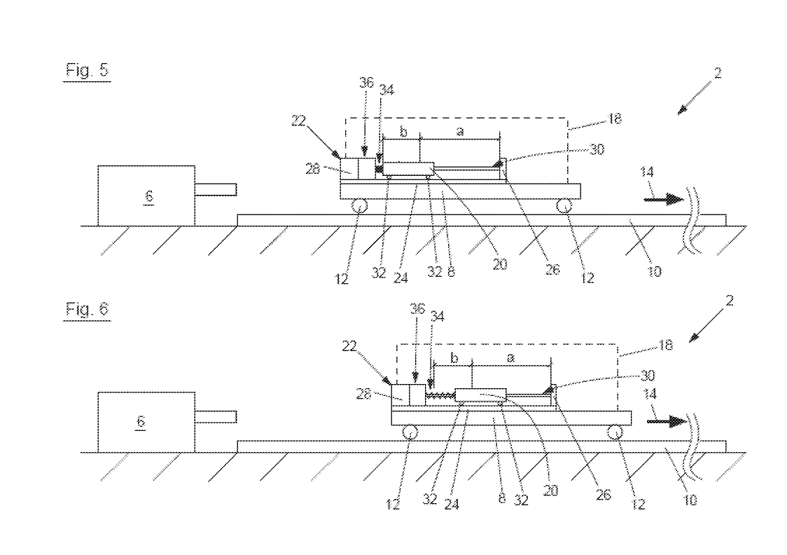

In the second phase of the preliminary test the second additional mass 20 following the first path a moves along a second path b, as is indicated in FIG. 5. During its movement along the second path b that continues to be caused by inertia, the second additional mass 20 is supported on the slide 8 in a resilient or/and damping manner via the spring or/and damping device 34 and the second support section 28. Thus, in the embodiment shown, the spring device 34 is elastically compressed through the moving second additional mass 20. Following the second path b, the second additional mass 20 is supported on the second support section 28 and thus on the slide 8 in a damping manner via the damping device 36, so that the second additional mass 20 is initially dampened and subsequently brought to a halt relative to the slide 8.

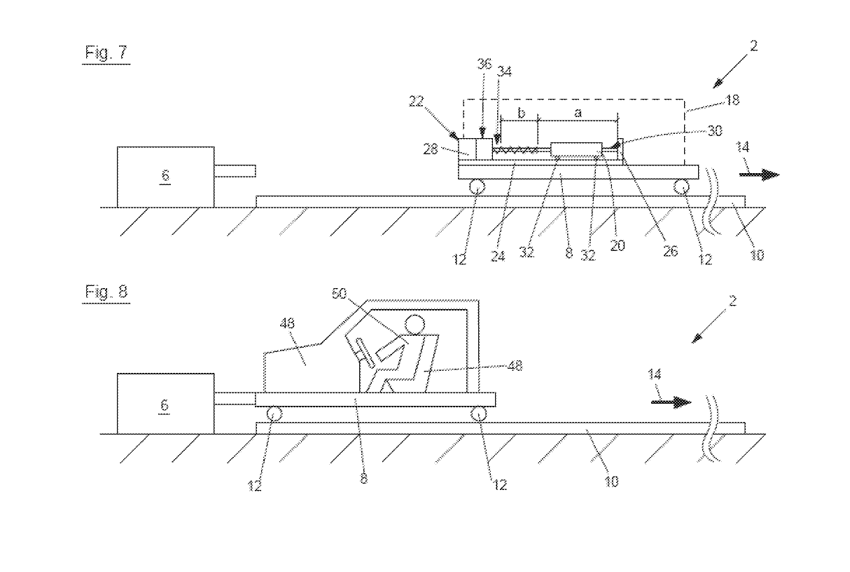

In a following phase of the preliminary test, which is shown in FIG. 6, the spring device 34 that is compressed in the preceding phase, causes the additional mass 20 to be accelerated again relative to the slide 8 in direction 14 until in a following phase of the preliminary test, which is shown in FIG. 7, the second additional mass 20 is again released from the spring device 34. In the phase shown in FIG. 7, the second additional mass 20 in turn moves freely along the first path a, this time however in direction 14 relative to the slide 8. In order to avoid that the second additional mass 20 strikes the first support section 26 too severely, braking devices which slow down or entirely stop the movement of the second additional mass 20 in direction 14 relative to the slide 8 are preferentially provided.

During the preliminary test, the acceleration curve of the slide 8 is determined in the method step 40 (FIG. 1) with the help of suitable measuring instruments. Following this or at the same time, the captured acceleration curve is compared with a desired acceleration curve of the slide 8. This is preferentially performed in that an upper limit acceleration curve and a lower limit acceleration curve is preset, between which a corridor is formed, within which the desired acceleration curve should be located. If the captured acceleration curve deviates from the desired acceleration curve in that it is arranged for example in part above the upper limit acceleration curve or in part below the lower limit acceleration curve, this is determined in method step 42 and a renewed preliminary test has to be carried out, as it is indicated by means of the arrow 44 in FIG. 1.

Before the renewed preliminary test however, the settings of the components of the crash simulation device 2 that are decisive for the acceleration curve of the slide 8 are initially changed in order to achieve a changed acceleration curve in the second preliminary test that better corresponds to the desired acceleration curve. Thus, preliminary tests are carried out until the settings of the components of the crash simulation device 2 that are decisive for the acceleration curve of the slide 8 are such that the captured acceleration curve corresponds to the desired acceleration curve of the slide 8 that is wanted.

When this is the case, the first additional mass 18 and the additional device 22 including the second additional mass 20 is removed from the slide 8 in method step 46, as is evident for example in FIG. 2. Following, a vehicle or vehicle part 48 is fastened to the slide 8, so that it is immovably connected to the slide 8. In addition to this, a moveable dummy 50 is arranged on the slide 8 or the vehicle or vehicle part 48. The moveable dummy 50 is preferentially a person dummy that is assigned a sensor system for capturing the forces, accelerations or/and speed acting on the dummy. Here, the corresponding sensor system can in part be preferentially integrated in the dummy 50. Thus, in contrast with the second additional mass 20 used in the preliminary test, the dummy 50 comprises a sensor system.

Creating this real test setup, which is shown in FIG. 8, takes place in the method step 52. Following this in method step 54, a real test is carried out with the settings of the components of the crash simulation device 2 that are decisive for the acceleration curve made in the preliminary test or the preliminary tests, during which the slide 8 in corresponding manner is shot or accelerated in direction 14 through the acceleration device 6.

It has been shown that the repetitive accuracy during the real test is significantly greater and unsuccessful tests can be avoided when the previously mentioned moveable second additional mass 20 or the additional device 22 with the second additional mass 20 is used in the preliminary tests, more so since because of this the acceleration behaviour of the real test setup can be depicted with particular accuracy even during the preliminary tests. Such an exact depiction of the real test even within the scope of the preliminary tests can then be achieved particularly securely if the dummy 50 used in the real test can be supported on the vehicle or vehicle part 48 or the slide 8 (not shown) by means of a safety belt or/and an airbag.

In order to be able to employ the additional device 22 described above with particular flexibility, the second additional mass 20 is exchangeably arranged on the additional device 22. In this manner, an additional mass can be used for the preliminary test in each case which substantially has the weight of the dummy 50 used in the real test later on. In addition, it is noted that the previously mentioned additional device 22 can also be arranged on the slide 8 in only a partially detachable manner. However, it is preferred that the additional device 22 is designed entirely detachable from the slide 8 in order to protect the individual components of the additional device 22 from damages during the real tests.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A method for operating a crash simulation device for a motor vehicles, comprising:
providing a crash simulation device with an accelerable slide;
fastening a first additional mass to the accelerable slide;
carrying out a preliminary test subject to capturing of a captured acceleration curve of the accelerable slide;
comparing the captured acceleration curve with a desired acceleration curve of the acceleration slide;
carrying out a second preliminary test with a changed setting of components of the crash simulation device that are decisive for an acceleration curve of the accelerable slide,
if the captured acceleration curve deviates from the desired acceleration curve,
removing the first additional mass from the accelerable slide, if the acceleration curve corresponds to the desired acceleration curve;
fastening of a part to the accelerable slide;
arranging moveable dummy; and
carrying out a real test with the settings of the components of the crash simulation device that are decisive for the acceleration curve of the accelerable slide; and
arranging a moveable second additional mass on the accelerable slide before carrying out the preliminary test.

2. The method according to claim 1, further removing the second additional mass from the accelerable slide before the carrying out the real test.

3. The method according to claim 1, further comprising indirectly arranging the second additional mass on the accelerable slide in that the second additional mass is arranged on the first additional mass.

4. The method according to claim 3, wherein the second additional mass together with the first additional mass is arranged on the accelerable slide together with said first additional mass.

5. The method according to claim 1, further comprising arranging the second additional mass on the slide in such a manner that the second additional mass is initially freely moveable along a first path and subsequently moveable along a second path subject to resilient supporting on the accelerable slide.

6. The method according to claim 5, further comprising arranging the second additional mass on the accelerable slide in such a manner that the second additional mass following the second path is supported on the accelerable slide in a damping manner.

7. The method according to claim 1, further comprising removing the additional device from the accelerable slide before carrying out the real test, wherein before the preliminary test an additional device is fastened to the accelerable slide, which comprises the second additional mass, a guiding device configured to guide the second additional mass and a damping device.

8. The method according to claim 1, wherein a second additional mass is used with a weight substantially corresponding to the weight of the dummy in the real test.

9. The method according to claim 1, further comprising using a dummy in the real test, which is assigned a sensor system that is configured to capture the forces, acting on the dummy, wherein the dummy a person dummy and the second additional mass is not assigned any sensor system.

10. An additional device for an accelerable slide of a crash simulation device, comprising:
a guiding device;
an additional mass configured to moved along the guiding device and
a fastening device configured for fastening to a slide of a crash simulation device.

11. The additional device according to claim 10, wherein the additional mass is guided in a freely moveable manner along a first path by the guiding device.

12. The additional device according to claim 11, further comprising:
a support section fastened to the slide of the crash simulation device;
a spring device configured to acting between the support section and the additional mass so that the additional mass following the first path subject to resilient supporting of said additional mass on the support section is guided by the guiding device along a second path.

13. The additional device according to claim 12, further comprising a damping device, which between the support section and the additional mass acts in such a manner that the additional mass following the second path is supported on the support section in a damping manner.

14. The additional device according to claim 10, wherein the additional mass is exchangeably arranged on the additional device.

15. A crash simulation device for a motor vehicle, comprising:
an accelerable slide;
an additional device fastened on the accelerable slide, the additional device comprising;
a guiding device;
an additional mass configured to move along the guiding device and
a fastening device configured for fastening to a slide of a crash simulation device,
the additional device is at least partially removable from the accelerable slide.

16. The crash simulation device according to claim 15, wherein the additional mass is guided in a freely moveable manner along a first path by the guiding device.

17. The crash simulation device according to claim 16, further comprising:
a support section fastened to the slide of the crash simulation device;
a spring device configured to act between the support section and the additional mass so that the additional mass following the first path subject to resilient supporting of said additional mass on the support section is guided by the guiding device along a second path.

18. The crash simulation device according to claim 17, further comprising a damping device, which between the support section and the additional mass acts in such a manner that the additional mass following the second path is supported on the support section in a damping manner.

19. The crash simulation device according to claim 15, wherein the additional mass is exchangeably arranged on the additional device.
